(19) United States
(12) Patent Application Publication
(10) Pub. No.: US 2015/0301819 A1
(43) Pub. Date: Oct. 22, 2015

(54) METHOD OF MANAGING A SCHEDULE-BASED SOFTWARE PACKAGE UPDATE

(71) Applicant: General Motors LLC, Detroit, MI (US)

(72) Inventors: Anthony J. Sumcad, Southfield, MI (US); Russell A. Patenaude, Macomb Township, MI (US)

(21) Appl. No.: 14/752,871

(22) Filed: Jun. 27, 2015

Related U.S. Application Data
(63) Continuation of application No. 12/234,284, filed on Sep. 19, 2008, now abandoned.

(51) Int. Cl. G06F 9/445; H04W 8/24; H04L 29/08

(52) U.S. Cl. CPC G06F 8/65; H04L 67/12; H04W 8/24

(57) ABSTRACT

A system and method of managing a vehicle software configuration includes: receiving from a user both a software package identifier for a software package that will be loaded onto a vehicle during a temporal period that is selected by the user and a vehicle identifier; identifying the software package associated with the software package identifier; wirelessly sending the software package from a central facility to the vehicle associated with the vehicle identifier for use during the user-selected temporal period; and storing the software package at the vehicle during the user-selected temporal period.

### CROSS REFERENCE TO RELATED APPLICATIONS

This application is a continuation application of application Ser. No. 12/234,284 filed Sep. 19, 2008, the entire contents of which are hereby incorporated by reference.

### TECHNICAL FIELD

The present invention relates generally to the updating of software packages and, more particularly, to managing the updating of software packages based on temporal windows.

### BACKGROUND OF THE INVENTION

Modern vehicles frequently use software to control or aid vehicle operation. This software is stored on the vehicle in various locations and forms and is accessed by vehicle system modules. Often, the software is stored on EEPROMs or other non-volatile digital memory, either on the vehicle system modules, at a telematics unit, or elsewhere on the vehicle. Storing software on digital memory permits an owner or vehicle engineer to update or change the software version when desired. But to do so, most existing techniques require that the owner or engineer manually direct the downloading of the vehicle software. When vehicles are scheduled for different users or uses during a particular day, a manual input initiates the downloading of software each time the new user or use is wanted. In such cases, each time a user wishes to operate the vehicle with a particular software package, the user must manually update the software stored on the vehicle by downloading a desired software package. An example of this situation occurs when two engineers periodically operate a test vehicle at different time periods. Throughout the course of a week, both engineers would manually download their respective software packages every day or time the respective engineers used the vehicle. The effort required may result in lost productivity from time spent manually downloading and situations where an incorrect software package or version has been loaded on the vehicle.

### SUMMARY OF THE INVENTION

According to an aspect of the invention, there is provided a method of managing a vehicle software configuration. The method includes receiving from a user both a software package identifier for a software package that will be loaded onto a vehicle during a temporal period that is selected by the user and a vehicle identifier; identifying the software package associated with the software package identifier; wirelessly sending the software package from a central facility to the vehicle associated with the vehicle identifier for use during the user-selected temporal period; and storing the software package at the vehicle during the user-selected temporal period.

According to another aspect of the invention, there is provided a method of managing a vehicle software configuration. The method includes identifying a group of vehicles using a plurality of vehicle identifiers, wherein the group of vehicles are maintained for evaluation by one or more users of the group of vehicles; establishing one or more temporal periods for one or more of the vehicles within the group during which the vehicle(s) will be evaluated by a user; receiving both a software package identifier representing a software package to be evaluated by one of the users during a user-selected temporal period and a vehicle identifier; wirelessly transmitting the software package associated with the software package identifier to the vehicle associated with the vehicle identifier; and storing the software package at the vehicle during the user-selected temporal period.

According to another aspect of the invention, there is provided a method of managing a vehicle software configuration. The method includes receiving a software package identifier, a temporal period, and a vehicle identifier from a user; accessing a centrally-located database that stores software package identifiers, temporal periods, and vehicle identifiers with users of software packages; searching the centrally-located database for a vehicle identifier associated with a vehicle; identifying the software package identifier(s) stored with the vehicle identifier in the centrally-located database; and wirelessly transmitting a software package associated with the identified software package identifier(s) to the vehicle for use during the temporal period.

### BRIEF DESCRIPTION OF THE DRAWINGS

One or more preferred exemplary embodiments of the invention will hereinafter be described in conjunction with the appended drawings, wherein like designations denote like elements, and wherein:

FIG. 1 is a block diagram depicting an exemplary embodiment of a communications system that is capable of utilizing the method disclosed herein; and

FIG. 2 is a flow chart depicting an exemplary embodiment of a method of updating software packages based on temporal windows.

### DETAILED DESCRIPTION OF THE PREFERRED EMBODIMENT(S)

The method described below attempts to update software packages based on temporal periods. Generally, a user specifies the software package(s) that any particular vehicle or fleet of vehicles will use or possess during a temporal period. A user or engineer may also define the boundaries and length of a temporal period(s). At the start or at any time during the temporal period, it is determined whether a vehicle is using or possessing the specified software package. If the vehicle does have the specified software package, a central facility or call center can refrain from sending the package. Alternatively, if the vehicle indicates that it does not have the specified software package, then the package is sent to the vehicle and stored in memory. Multiple temporal periods can be established using this method with multiple software packages associated with each period. Using this method, users or engineers using a vehicle at different times can ensure that the vehicle will have the specified software package at a desired time without manual initiation. This method can be helpful when a user or engineer knows that a particular software package will be in use during certain times of the day. Rather than loading the software manually each day, a preset schedule or temporal windows helps ensure correct software is on the vehicle. For example, when a first temporal period begins, a first software package may be stored on the vehicle. But when the first temporal period ends and a second temporal period begins, a second software package can be downloaded to the vehicle and stored without manual initiation from the user. Using this method, the user or engineer no longer manually checks to ensure a desired software program is stored on the vehicle each time he uses the vehicle. Instead, the user or engineer need only establish a temporal period and a software package, link it to the vehicle, and the method will automatically ensure the vehicle has possession of the correct software.

### Communications System—

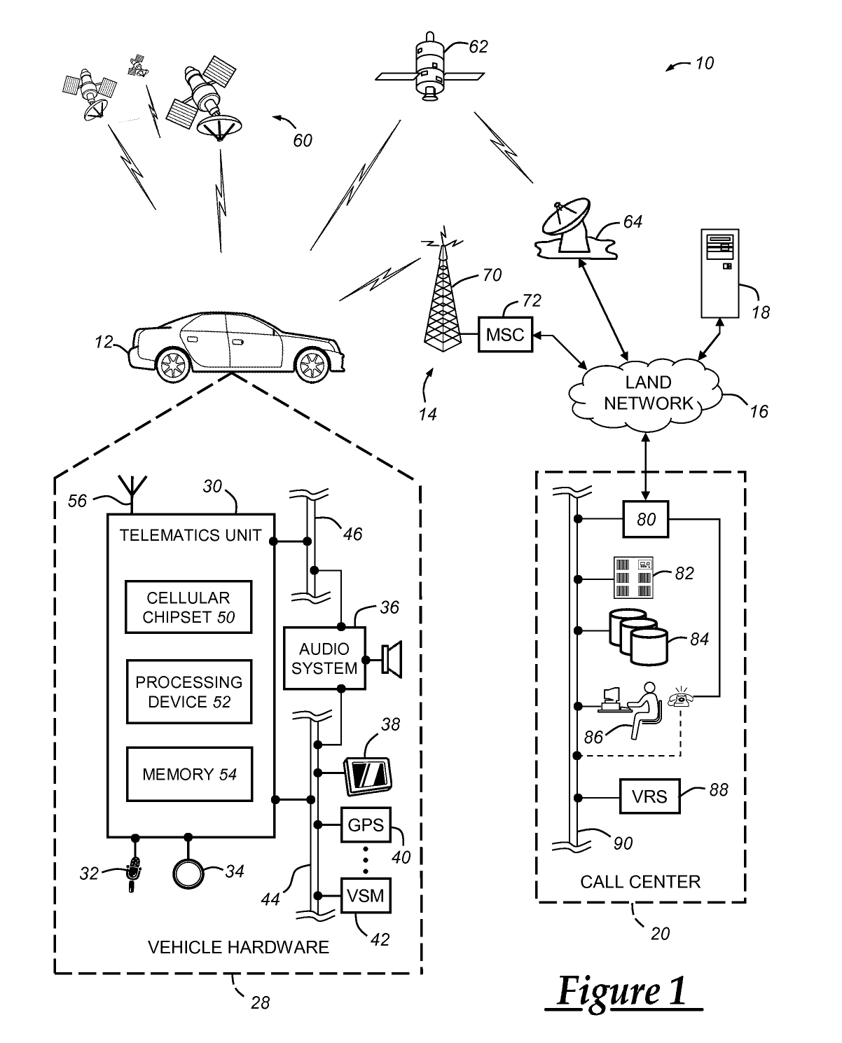

With reference to FIG. 1, there is shown an exemplary operating environment that comprises a mobile vehicle communications system 10 and that can be used to implement the method disclosed herein. Communications system 10 generally includes a vehicle 12, one or more wireless carrier systems 14, a land communications network 16, a computer 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such exemplary system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 is an OEM-installed device that enables wireless voice and/or data communication over wireless carrier system 14 and via wireless networking so that the vehicle can communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM or CDMA standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, such as any of the IEEE 802.11 protocols, WiMAX, or Bluetooth. When used for packet-switched data communication such as TCP/IP, the telematics unit can be configured with a static IP address or can set up to automatically receive an assigned IP address from another device on the network such as a router or from a network address server.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

### Managing Method—

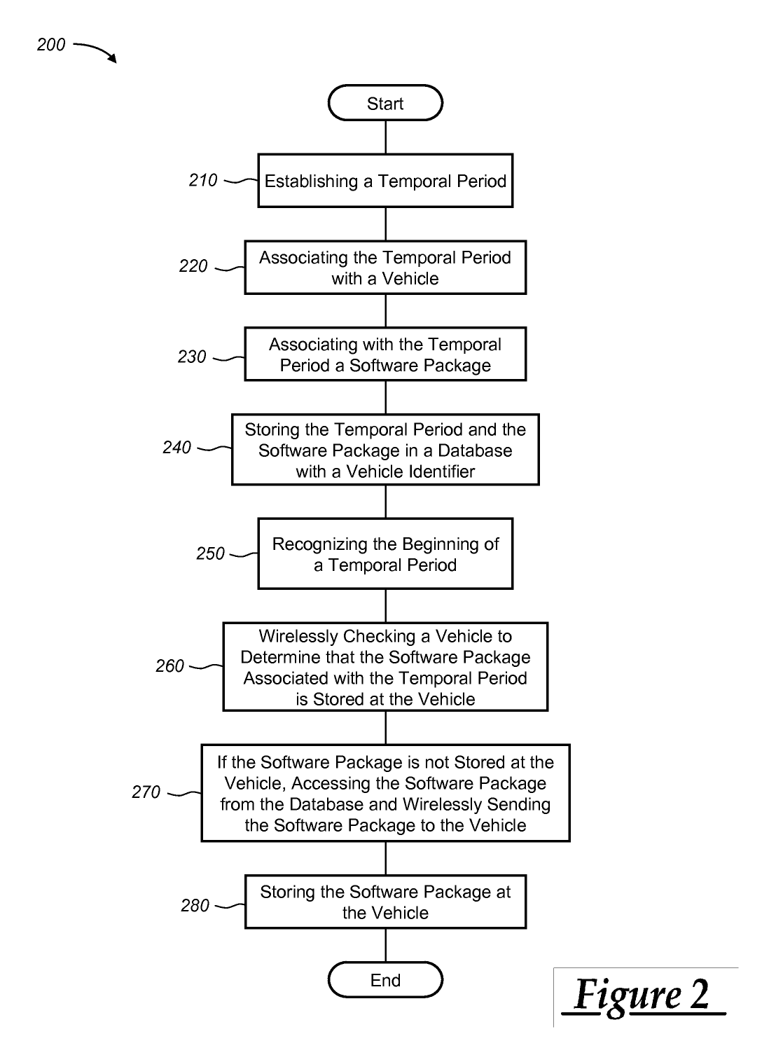

Turning now to FIG. 2, there is a method for managing the updating of a vehicle software configuration. Method 200 automatically updates software packages on vehicles based on temporal periods.

The method 200 begins at step 210 where a temporal period is established. A temporal period may be a period of time established by a user. For example, a user may have possession of a vehicle 12 and use a software package during weekday mornings. In this case, a temporal period may be established as 8 AM-12 PM occurring Monday through Friday. In another example, a user may want to use a particular software package on a vehicle 12 Monday, Wednesday, and Friday. If so, the temporal window may begin at 12 AM Monday, end at 12 AM Tuesday, and begin again at 12 AM Wednesday continuing in periodic fashion. In another example, temporal periods may be predefined and established at the call center 20 or vehicle 12 and allow a user to assign a particular software package to the predefined temporal periods. For instance, the user may choose from mornings or evenings. In another example, the call center 20 may provide variables such as AM, PM, day of the week, and month. Using these variables, a user can configure a temporal period based on these variables. In short, a temporal period may be highly customizable allowing a user to establish very detailed schedules having less periodicity, the temporal period can be very basic, such as day of the week, having more periodicity, or any combination thereof.

The temporal period may be established from a variety of locations. In one embodiment, a user may access a web portal using the computer 18 where the variables such as time, day, and month may be entered into a graphical user interface. Using the land network 16, the variables may be sent to the call center 20 and either stored in databases 84 or sent to the telematics unit 30 of the vehicle 12 and stored in memory 54. In another embodiment, a user may telephone a call center 20 and, using voice prompts provided by an automatic speech recognition system (ASR), verbally provide the variables to the call center 20. Alternatively, the voice prompts may be provided by the ASR system in a vehicle 12 through the audio system 36. In this case, when the user is in the vehicle 12, the user can enunciate the variables into the microphone 32 and the variables may be stored in memory 54 or transmitted by the telematics unit 30 to the call center 20 where they may be stored in databases 84. Using ASR and web portals, the user may establish temporal periods at any time of the day or night. The method then proceeds to step 220.

At step 220, the temporal period is associated with a vehicle 12. In order to associate a vehicle 12 with the temporal period, the method 200 identifies a vehicle 12 or group of vehicles 12. Each vehicle uses a vehicle identifier permitting a user to assign the temporal window to a particular vehicle 12. The vehicle identifier may take a variety of forms. For example, a user may use the vehicle identification number (VIN) of the vehicle he wishes to manage, in which case the vehicle identifier is unique to that vehicle. The unique VIN may facilitate the association of temporal periods of individual vehicles 12. Alternatively, a user may associate the temporal period with a group of vehicles 12 using the non-serial number portion of the VIN or using other vehicle identifiers such as manufacturer, model, model year, color, trim level, date of manufacture, or some other vehicle feature in addition to using the VIN. Using the desired identifier, the user can assign one or multiple temporal periods with the vehicle 12. For individual vehicles, by using a unique identifier such as the VIN, then for any particular temporal period, it is known which vehicle uses a particular software package. Much like establishing the temporal period in step 210, the vehicle identifier may be established from a variety of locations. As discussed above, the user may access a web portal or the user may verbally provide the identifier(s) to the call center 20 using the automatic speech recognition system (ASR), either in the vehicle or from a telephone. The method then proceeds to step 230.

At step 230, an update software package is identified or otherwise provided for use, and the temporal period is associated with that software package. For the duration of each temporal period, the user specifies at least one software package that will be stored on the vehicle 12. Accordingly, when the user establishes a temporal period and associates the period with a vehicle 12, the user may also specify the software package(s) that will be stored on the vehicle 12 during the temporal period. One example of multiple software packages associated with a temporal period includes situations where an engineer compares two software packages simultaneously on a vehicle 12. The software package(s) can be identified by file name where the file name corresponds to the name of a software file stored either in memory 54 at the vehicle 12 or in databases 84 at the call center 20. The file name can also include more specific identifying information, such as file type and file size, aiding in the identification of the software package. Much like establishing the temporal period in step 210, associating a software package with a temporal period may be accomplished from a variety of locations. As discussed above, the user may access a web portal or the user may verbally identify the software package by file name or a combination of file name, file type, and file size to the call center 20 using the automatic speech recognition system (ASR), either in the vehicle 12 or from a telephone. At this point in the method 200, a vehicle 12 is associated with at least one temporal period and for each temporal period at least one software package is identified to be stored on the vehicle 12. The method then proceeds to step 240.

At step 240, the temporal period and the software package is stored in a database with a vehicle identifier. The vehicle identifier, the temporal period(s), and the software package(s) associated with the temporal period(s) may be associated as a data unit and stored in a database. And the data unit may be organized in a variety of ways. For example, the data unit may be stored in a database according to the temporal period. When the data unit is stored in the database according to the temporal period, the time of day can be determined and cross-referenced with the vehicles and temporal period determining the software packages that should be stored on the vehicles 12 at the determined time of day. In another example, the data unit may be stored according to the vehicle identifier. Using the identifier, a vehicle 12 or group of vehicles 12 can be identified and the software packages and temporal periods associated with the vehicle 12 or group of vehicles 12 can be determined. In one example, the data units can be stored at the vehicle 12 in the memory 54. In another example, the data units may be stored at the call center 20 in the databases 84. Additionally, the web portal or ASR system can be used to modify previously established data units. For instance, if a user establishes the temporal window, the vehicle, and a first software package associated with the window, the user may use the portal or ASR to substitute a second software package for the first software or add the second software package to the data unit in addition to the first software package. The method then proceeds to step 250.

At step 250, the beginning of a temporal period is recognized. The beginning of a temporal period is the start time at which the temporal period is in effect. For instance, if the temporal period is established as 8 AM-12 PM occurring Monday through Friday, the beginning of the temporal period is 8 AM Monday through Friday. Alternatively, the beginning of the temporal period can use a time delay or advance of a few minutes or seconds. The time delay can help alleviate spikes in data transmissions over wireless networks 14 and land networks 16. For instance, the beginning of a temporal period in the above example can be delayed one minute until 8:01 AM for a group of vehicles 12 that can be designated by vehicle identifiers. In one example, the beginning of the temporal period can be recognized using the vehicle telematics unit 30. The telematics unit 30 can establish the time using the GPS module 40, the cellular chipset 50, or an internal clock. The telematics unit 30 can access data units stored in memory 54 and cross reference the temporal period(s) of the data unit with the established time. In another example, the call center 20 can establish the time of the day and access the data units stored in databases 84. The call center 20 can cross reference the temporal period(s) stored in the data units with the established time to determine the beginning of the temporal period. The method then proceeds to step 260.

At step 260, a vehicle 12 is wirelessly checked to determine that the update software package associated with the temporal period is stored at the vehicle. For example, if the beginning of a temporal period is determined at a call center 20, the call center 20 can send an SMS message to the telematics unit 12. The SMS message can include the file name, file type, and/or the file size of the software package(s) that should be stored at the vehicle 12. The message can also request the telematics unit 30 check the memory 54 and the VSMs 42 for the file names, file types, and/or file sizes of software packages stored therein. The telematics unit 30 can then compare the file names, file types, and/or file sizes stored in the memory 54 or in the VSMs 42 with the file names, file types, and/or file sizes indicated in the message. If the telematics unit 30 determines that the file names, file types, and/or file sizes from the message sent from the call center 20 match the stored file names, file types, and/or file sizes, the unit 30 can send an SMS message to the call center 20 indicating this status. Alternatively, if the telematics unit 30 determines that the file names, file types, and/or file sizes from the message sent from the call center 20 do not match the stored file names, file types, and/or file sizes, the unit 30 can send an SMS message to the call center 20 indicating that files from the software package(s) are needed.

In another example, if the beginning of a temporal period is determined at the vehicle 12, the telematics unit 30 can access the data units stored in the memory 54 and determine the software package(s) stored with the data unit. The telematics unit 30 can then access the software package(s) stored in the memory 54 or VSMs 42 and compare the software package(s) stored in the memory 54 or VSMs 42 with the software package(s) stored with the data unit. If the telematics unit 30 determines that the file names, file types, and/or file sizes from the message sent from the call center 20 match the stored file names, file types, and/or file sizes, the unit 30 can send an SMS message to the call center indicating this status. Alternatively, if the telematics unit 30 determines that the file names, file types, and/or file sizes from the message sent from the call center 20 do not match the stored file names, file types, and/or file sizes, the unit 30 can send an SMS message to the call center 20 indicating that the files from the software package are needed. In this example, checking whether the software package associated with the temporal period is stored at the vehicle can be accomplished either wirelessly or through the vehicle data bus 44. The method then proceeds to step 270.

At step 270, if the software package is not stored at the vehicle 12, the software package is accessed from the database and wirelessly sent to the vehicle 12. For instance, if the call center 30 receives the SMS message that indicates that the software package associated with the temporal period is not stored on the vehicle 12, the call center 20 can access the databases 84 and retrieve the files associated with the software package. The call center 20 can then wirelessly transmit the software package to the telematics unit 30. The package can be transmitted with a data transmission via any of the methods discussed regarding the communications system or known to those skilled in the art. In another example, the telematics unit 30 may have the software package associated with the temporal period stored in memory 54. In that case, the telematics unit 30 need not send an SMS message to the call center 20. Rather, the telematics unit 30 can access the software package associated with the temporal period and download it to the VSMs 42 or other suitable memory location. The method then proceeds to step 280.

At step 280, the software package is stored at the vehicle. In one example, the vehicle 12 stores the software package in the memory 54 of the telematics unit 30. In another example, the software package is downloaded from the telematics unit 30 onto individual VCUs 42.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of managing a vehicle software configuration on one or more test vehicles used by vehicle engineers, comprising the steps of:
(a) receiving from a vehicle engineer (i) a vehicle identifier that is associated with at least one test vehicle, (ii) a software package identifier that is associated with a software package to be used by the vehicle engineer on the at least one test vehicle, and (iii) a preset schedule comprising a temporal period specified by the vehicle engineer that includes one or more temporal windows during which the vehicle engineer will use the software package on the test vehicle;
(b) identifying one or more test vehicles using the vehicle identifier;
(c) identifying the software package associated with the software package identifier;
(d) wirelessly sending the software package from a central facility to the one or more test vehicles identified by the vehicle identifier for use during the engineer-specified temporal period;
(d) storing the software package at the one or more test vehicles during the engineer-specified temporal period; and
(e) using the software package on the one or more test vehicles during the temporal period while the one or more vehicles are being used by the vehicle engineer.

2. The method of claim 1, further comprising the steps of:
(f) receiving from a second vehicle engineer a software package identifier for a second software package that will be loaded onto the one or more test vehicles during a second temporal period that is selected by the second vehicle engineer;
(g) determining that the one or more test vehicles do not have the second software package identified by the second vehicle engineer;
(h) wirelessly sending, in response to step (g), the second software package from the central facility to the one or more test vehicles for use during the second temporal period; and
(i) storing the second software package at the one or more test vehicles.

3. The method of claim 2, further comprising the step of deleting the software package stored at step (d) during the second temporal period.

4. The method of claim 1 further comprising the step of determining if the one or more test vehicles do not have the software package during the engineer-specified temporal period.

5. The method of claim 1, wherein the temporal period includes multiple time windows that occur daily or weekly.

6. The method of claim 1, wherein the software package controls at least one aspect of vehicle operation.

7. The method of claim 1, wherein step (a) further comprises receiving input from the vehicle engineer that establishes the beginning and the end of the temporal period.

8. The method of claim 1, further comprising the steps of providing a user interface that identifies a plurality of software package identifiers for the vehicle engineer to select.

9. The method of claim 1, further comprising the step of providing a portal allowing the vehicle engineer to substitute software packages and alter the engineer-specified temporal period.

10. A method of managing a vehicle software configuration, the method comprising:
(a) identifying a group of vehicles using a plurality of vehicle identifiers, wherein the group of vehicles are maintained for evaluation by one or more users of the group of vehicles;
(b) establishing one or more temporal periods for one or more of the vehicles within the group during which the vehicle(s) will be evaluated by a user;
(c) receiving both a software package identifier representing a software package to be evaluated by one of the users during a user-selected temporal period and a vehicle identifier;
(d) wirelessly transmitting the software package associated with the software package identifier to the vehicle associated with the vehicle identifier; and
(f) storing the software package at the vehicle during the user-selected temporal period.

11. The method of claim 10, wherein the method further comprises the steps of:
substituting a second software package for the software package based on user input; and
wirelessly transmitting the second software package to the vehicle based on the substitution.

12. The method of claim 10, further comprising the step of determining if the vehicle associated with the vehicle identifier does not have the software package during the user-selected temporal period.

13. The method of claim 10, wherein the temporal periods occur daily or weekly.

14. The method of claim 10, wherein the software package controls at least one aspect of vehicle operation.

15. The method of claim 10, further comprising the step of receiving user input establishing the beginning and the end of the user-selected temporal period.

16. The method of claim 10, further comprising the step of providing a portal allowing the user to substitute software packages and alter the user-selected temporal period.

17. A method of managing a vehicle software configuration, the method comprising:
(a) receiving a software package identifier, a temporal period, and a vehicle identifier from a user;
(b) accessing a centrally-located database that stores software package identifiers, temporal periods, and vehicle identifiers with users of software packages;
(c) searching the centrally-located database for a vehicle identifier associated with a vehicle;
(d) identifying the software package identifier(s) stored with the vehicle identifier in the centrally-located database; and
(e) wirelessly transmitting a software package associated with the identified software package identifier(s) to the vehicle for use during the temporal period.

18. The method of claim 17, wherein the method further comprises the steps of:
substituting a second software package for the software package associated with the software package identifier based on user input; and
wirelessly transmitting the second software package to the vehicle based on the substitution.

19. The method of claim 17, further comprising the step of determining if the vehicle associated with the vehicle identifier does not have the software package during the temporal period.

20. The method of claim 17, wherein the software package controls at least one aspect of vehicle operation.
